(19) United States
(12) Patent Application Publication
(10) Pub. No.: US 2018/0225704 A1
(43) Pub. Date: Aug. 9, 2018

(54) INFLUENCE MEASUREMENT DEVICE AND INFLUENCE MEASUREMENT METHOD

(71) Applicant: NEC Corporation, Minato-ku, Tokyo (JP)

(72) Inventors: Jun KOBAYASHI, Tokyo (JP); Shinichi ANAMI, Tokyo (JP)

(73) Assignee: NEC Corporation, Minato-ku, Tokyo (JP)

(21) Appl. No.: 15/750,915

(22) PCT Filed: Aug. 24, 2016
(86) PCT No.: PCT/JP2016/074635

§ 371 Date: Feb. 7, 2018

(30) Foreign Application Priority Data
Aug. 28, 2015 (JP) 2015-169784

(51) Int. Cl. G06Q 30/02

(52) U.S. Cl. CPC G06Q 30/0242; G06Q 30/0201

(57) ABSTRACT

The influence measurement device measures the influence of a moving first subject, for example, a person or an advertisement vehicle, on a second subject such as a person. The influence measurement device is equipped at least with: a measurement unit for measuring at least a influence; and an output unit for outputting the influence. Specifically, the influence measurement device determines whether there is a second subject on which a first subject may have an influence, determines whether there is a reaction from the second subject, and measures the influence of the first subject on the second subject based on the determination result. Also, the influence measurement device may be configured such that the presence of the second subject and the reaction from the second subject are determined by analyzing image data captured of the second subject from the first subject by using a camera.

### TECHNICAL FIELD

The present invention relates to an influence measurement device and an influence measurement method for measuring an influence of a person or an object (an influencer) exerting a great influence on other people on internet media or the like.

This application is based upon and claims the benefit of priority from the Japanese Patent Application No. 2015-169784 filed on Aug. 28, 2015, the contents of which are incorporated herein.

### BACKGROUND ART

On consumer-generated media such as blogs, video sites, and social networking services, key persons whose messages have a great influence on other people in a field of internet marketing in particular is known in recent years as influencers. In addition, thing that is a video display device installed in an outdoor location or at a store and is a computerized sign, poster and the like which presents guidance information, an advertisement or the like to people near the device or passengers is known as digital signage. Further, a system that measures responses of viewers to information presented on digital signage or the like has been developed.

Various techniques relating to influencers and digital signage described above have been developed. PTL 1 discloses a technique of performing person tracking and providing interactive advertisements in an advertising station that provides advertising contents to potential customers. In the technique, a camera captures an image of a potential customer watching a display that provides an advertising content, and an interest level of the potential customer in the advertising content is determined based on a gaze direction and a body pose direction of the potential customer. PTL 2 discloses an influence calculation device and an influence calculation method for calculating an influence of posting information in social media and the like. PTL 3 discloses an advertisement distribution system capable of counting click through rates (CTR) of advertising information in a digital signage system. PTL 4 discloses an influencer extracting device and an influencer extracting method for extracting, as an influencer, a user who has provided posting information widespread on social media. PTL 5 discloses an attention level measurement device and an attention level measurement method capable of measuring levels of attention of people to media information such as advertising media based on an image captured with a camera installed near an advertisement media presentation device.

### CITATION LIST

### Patent Literature

### [PTL 1] Japanese Laid-open Patent Publication No. 2013-050945

### [PTL 2] Japanese Laid-open Patent Publication No. 2012-203499

### [PTL 3] Japanese Laid-open Patent Publication No. 2012-098991

### [PTL 4] Japanese Laid-open Patent Publication No. 2012-078933

### [PTL 5] Japanese Laid-open Patent Publication No. 2010-108257

### SUMMARY OF INVENTION

### Technical Problem

In the technique described above, the level of interest of the potential customer in advertising information displayed on an immobile entity such as a display and digital signage is determined, and no technique has been achieved that determines the level of interest of the potential customer in information provided by a moving entity such as a person and an advertisement vehicle.

The present invention has been made in order to solve the problem described above and an object of the present invention is to provide an influence measurement device and an influence measurement method for measuring an influence of an influencer on other people.

### Solution to Problem

A first aspect of the present invention is an influence measurement device, the influence measurement device includes:

a measurement unit that measures an influence of a moving first subject on a second subject; and

an output unit that outputs the influence measured by the measurement unit.

A second aspect of the present invention is an influence measurement method, the influence measurement method includes:

measuring an influence of a moving first subject on a second subject; and,

outputting the measured influence.

### Advantageous Effects of Invention

According to the present invention, an influence of a moving first subject such as a person and an advertisement vehicle on a second subject such as a person can be measured.

### BRIEF DESCRIPTION OF DRAWINGS

FIG. 1 is a block diagram of a network system that implements functions of an influence measurement device according to the present invention.

FIG. 2 is a block diagram of the influence measurement device according to a first example embodiment of the present invention.

FIG. 3 is a block diagram of an advertisement vehicle equipped with the influence measurement device according to the first example embodiment.

FIG. 4 is a flowchart illustrating a procedure of processing performed by the influence measurement device according to the first example embodiment.

FIG. 5 is a block diagram illustrating an influence measurement device according to a second example embodiment of the present invention.

FIG. 6 is a block diagram illustrating a configuration in which functions of the influence measurement device according to the second example embodiment are applied to an advertisement vehicle and a flying object.

FIG. 7 is a block diagram of an influence measurement device according to a third example embodiment of the present invention.

FIG. 8 is a block diagram illustrating a configuration of an implementation in which functions of the influence measurement device according to the third example embodiment are implemented in corporation with a server.

FIG. 9 is a flowchart illustrating a procedure of processing performed by the influence measurement device according to the third example embodiment.

FIG. 10 is a block diagram illustrating a minimum configuration of an influence measurement device according to the present invention.

FIG. 11 is a flowchart illustrating a procedure of processing performed by the influence measurement device.

### DESCRIPTION OF EMBODIMENTS

Example embodiments of influence measurement device and influence measurement method according to the present invention will be described in detail with reference to the accompanying drawings. First, a network system 3 that implements functions of an influence measurement device 10 according to the present invention will be described.

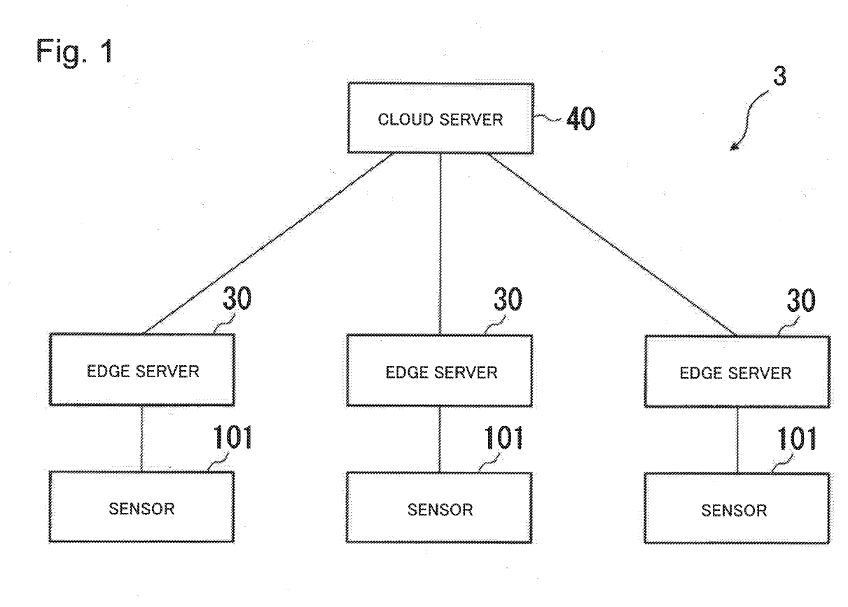

FIG. 1 is a block diagram of a network system 3. The network system 3 includes sensors 101, edge servers 30, and a cloud server 40. Each of the edge servers 30 is installed near end-users severally and the cloud server 40 is a server that causes a plurality of servers to operate as if the servers were a single server. In the network system 3 illustrated in FIG. 1, each of the edge servers 30 is installed near the sensor 101 severally and the cloud server 40 is connected to the edge servers 30.

In the network system 3 in FIG. 1, the edge servers 30 are each connected to each of the sensors 101 and the plurality of edge servers 30 are connected to the cloud server 40. In this case, for example, the edge servers 30 may include functions of the influence measurement device 10. Alternatively, functional units included in the influence measurement device 10 may be distributed among the plurality of edge servers 30. Further, the functional units included in the influence measurement device 10 may be distributed between each of the edge servers 30 and the cloud server 40. Note that the functions of the influence measurement device 10 are not limited to being implemented by the edge servers 30 and/or the cloud servers 40 in the network system 3. The functions of the influence measurement device 10 may be implemented by a device into which a server and a sensor are integrated.

When the functions of the influence measurement device 10 are implemented by the network system 3, a discount coupon or points may be given to a first subject (for example, an influencer) based on the influence of the first subject on second subjects (for example, persons, animals, etc.). Hereinafter, the first subject is referred to as a “subject to be measured (or an entity to be measured)” of the influence measurement device 10 and the second subject is referred to as a “subject influenced (or a subject)”. With this, the entity to be measured (influencer) can buy a product at a low price depending on the influence on subjects. Further, a company such as a manufacturer or a dealer that provides products bought using such discount coupons or points can benefit because the product sales increase through advertising the products by the entity to be measured to subjects.

### First Example Embodiment

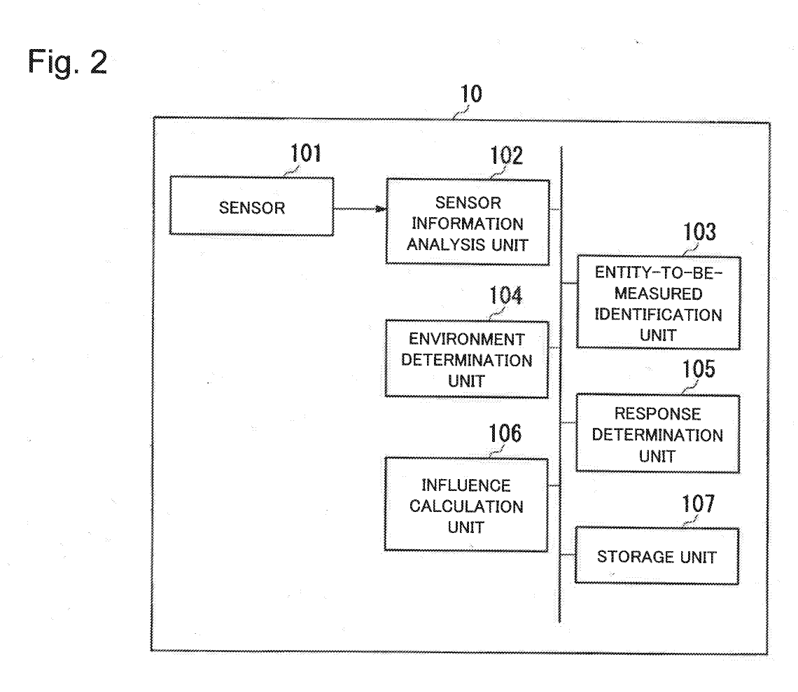

The influence measurement device 10 according to a first example embodiment of the present invention will be described. FIG. 2 is a block diagram of the influence measurement device 10. The influence measurement device 10 includes the sensor 101, a sensor information analysis unit 102, an entity-to-be-measured identification unit (identification unit) 103, an environment determination unit (first determination unit) 104, a response determination unit (second determination unit) 105, an influence calculation unit 106 and a storage unit 107. Note that the sensor information analysis unit 102, the entity-to-be-measured identification unit 103, the environment determination unit 104, the response determination unit 105 and the influence calculation unit 106 will be collectively referred to as a measurement unit.

The sensor 101 detects a physical quantity for extracting a subject that is influenced by an entity to be measured. For example, the sensor 101 is an image sensor which detects light and converts the light to image information.

The sensor information analysis unit 102 applies processing to detection information concerning a physical quantity detected by the sensor 101. For example, when the sensor 101 is the image sensor, the sensor information analysis unit 102 acquires image information from the sensor 101 and performs image analysis such as face recognition on the image information to extract a person.

The entity-to-be-measured identification unit 103 identifies the entity to be measured that is likely to be influencing persons or the like. For example, an association between identification information (ID) of the influence measurement device 10 and identification information (ID) of the entity to be measured is stored in the storage unit 107 in advance. The entity-to-be-measured identification unit 103 acquires the ID of the influence measurement device 10 and reads out the association between the influence measurement device 10 and the entity to be measured from the storage unit 107. The entity-to-be-measured identification unit 103 identifies the sensor 101 provided in the influence measurement device 10 identified by the ID written in the association and identifies an entity equipped with the sensor 101 as the entity to be measured that is likely to be the influencing subjects.

The environment determination unit 104 determines whether the entity to be measured identified by the entity-to-be-measured identification unit 103 is in an environment in which a subject influenced by the entity to be measured exists, i.e. whether the subject which is likely to be influenced by the entity to be measured identified by the entity-to-be-measured identification unit 103 exists. For example, when the sensor information analysis unit 102 has extracted a person from the detection information, the environment determination unit 104 determines that the entity to be measured is in the environment in which the subject that is likely to be influenced by the entity to be measured exists. On the other hand, when the sensor information analysis unit 102 does not extract a person, the environment determination unit 104 determines that the entity to be measured is not in the environment in which the subject that is likely to be influenced by the entity to be measured exists, i.e. determines that such subject does not exist. When the environment determination unit 104 determines that the entity to be measured is in the environment in which the subject exists, it can be said that the entity to be measured is likely to influence the subject in the real world. On the other hand, when the environment determination unit 104 determines that the entity to be measured is not in the environment in which the subject exists, the subject that is likely to be influenced in the real world by the entity to be measured does not exist and therefore it can be said that the entity to be measured does not need to perform an activity that influence the subject.

The response determination unit 105 determines whether a response from the subject that is influenced by the entity to be measured is received. For example, the response determination unit 105 determines a direction of the face of each person extracted by the sensor information analysis unit 102 using image analysis technique. Specifically, images of a model person's face are captured from various angles (directions), and each of the angles is associated with the face including positional relationships between parts of the face such as the eyes and the mouth at that angle and stored in the storage unit 107 in advance. The response determination unit 105 compares each person's face extracted by the sensor information analysis unit 102 with the faces stored in the storage unit 107 in advance and identifies a face that has the positional relationship between face parts that matches that of the face among the faces stored in the storage unit 107. The response determination unit 105 determines that the angle associated with the identified face is the direction of the face. When the direction of the identified face is toward the sensor 101, the response determination unit 105 determines that the response from the subject is received. The response determination unit 105 determines that the greater the number of persons extracted by the sensor information analysis unit 102 and turning their faces to the sensor 101, the more responses are returned from the subjects. Further, when the direction of the identified face is not turned to the sensor 101, the response determination unit 105 determines that no response from the subject is received.

The influence calculation unit 106 calculates an influence score indicating the influence (i.e. one example of information indicating influence of a moving entity to be measured on subjects) based on the responses from subjects identified by the response determination unit 105. For example, when the number of responses from subjects determined by the response determination unit 105 is 100, the influence calculation unit 106 outputs the influence score of “100” by calculation. When the number of responses from subjects determined by the response determination unit 105 is 123, the influence calculation unit 106 outputs the influence score of “123” by calculation.

The storage unit 107 stores various kinds of information required for processing performed by the influence measurement device 10. For example, the storage unit 107 stores an association between the ID of the influence measurement device 10 and the ID of the entity to be measured.

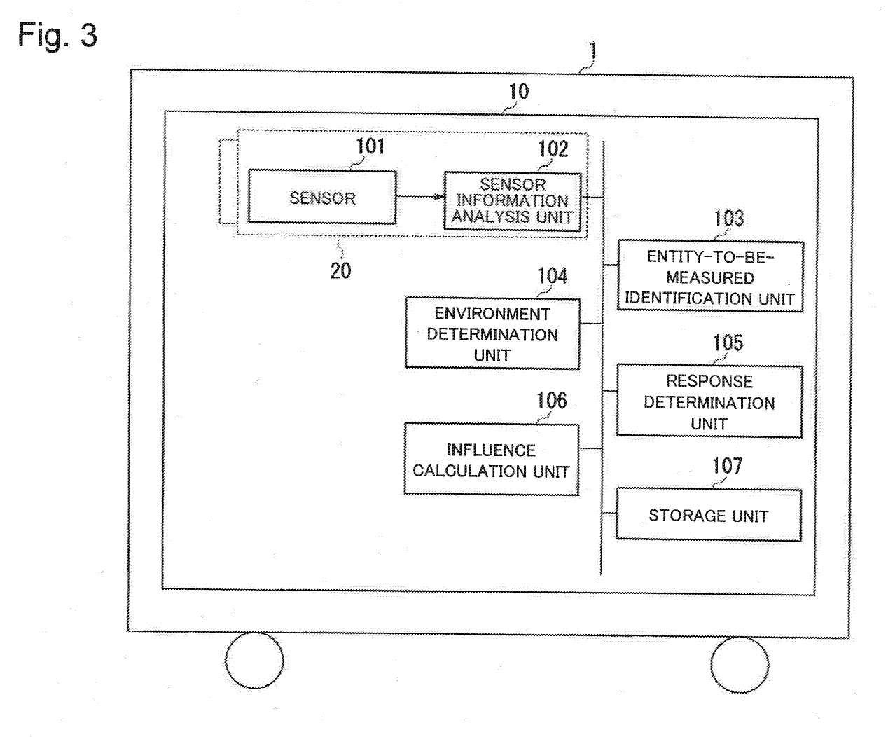

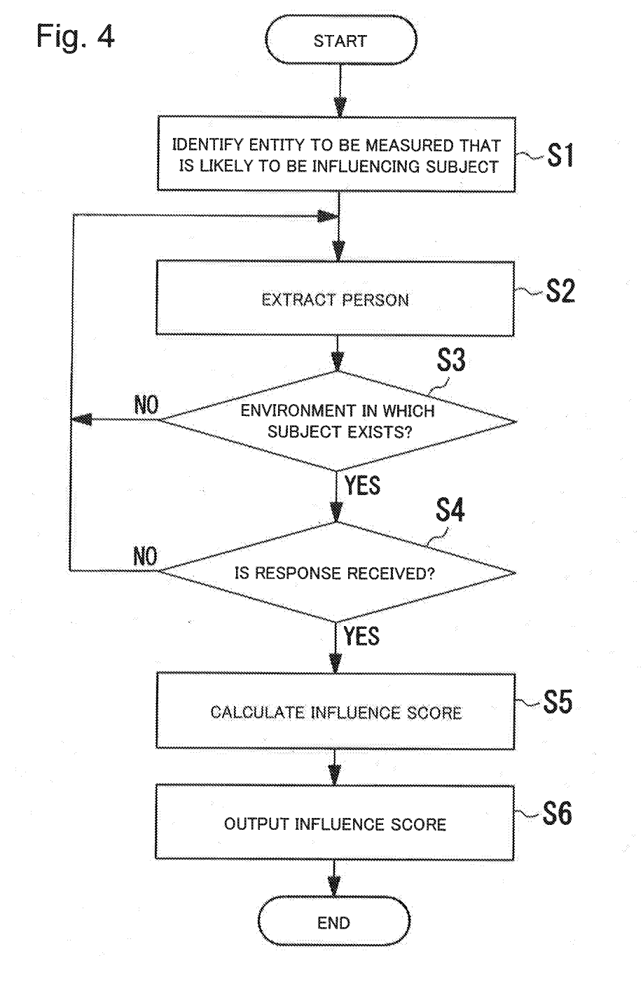

Next, Processing performed by the influence measurement device 10 according to the first example embodiment will be described with reference to FIGS. 3 and 4. FIG. 3 illustrates the influence measurement device 10 provided in an advertisement vehicle 1 which is the entity to be measured and FIG. 4 illustrates a procedure of processing performed by the influence measurement device 10. Note that the sensor 101 and the sensor information analysis unit 102 are embedded in a camera 20 provided in such a way that the camera 20 can capture images of subjects in front of an advertisement displayed on the advertisement vehicle 1. In other words, the sensor 101 is an image sensor embedded in the camera 20.

The entity-to-be-measured identification unit 103 reads out, from the storage unit 107, an association between the influence measurement device 10 and the advertisement vehicle 1 which uses the influence measurement device 10 to determine the influence of the entity to be measured on subjects. Based on the association read out from the storage unit 107, the entity-to-be-measured identification unit 103 identifies the advertisement vehicle 1 equipped with the sensor 101 as the entity to be measured that is likely to be the influencing subjects (step S1).

The advertisement vehicle 1 runs along any route including stopping locations. When the advertisement vehicle 1 starts running along the route, the camera 20 starts to capture images of subjects in front of the advertisement. The sensor 101 detects light and converts the light to image information.

The sensor information analysis unit 102 acquires the image information from the sensor 101 at regular intervals. The sensor information analysis unit 102 performs image analysis such as face recognition on the image information to identify the subject (person) (step S2). The sensor information analysis unit 102 sends a result of the person extraction to the environment determination unit 104 and the response determination unit 105.

The environment determination unit 104 receives the result of the person extraction from the sensor information analysis unit 102. Based on the result of the person extraction, the environment determination unit 104 determines whether the entity to be measured is in the environment in which the subject that is influenced by the entity to be measured exists (step S3). Specifically, when the sensor information analysis unit 102 extracts a person, the environment determination unit 104 determines that the entity to be measured is in the environment in which the subject exists. On the other hand, when the sensor information analysis unit 102 does not extracts a person, the environment determination unit 104 determines that the entity to be measured is not in the environment in which the subject exists.

When the environment determination unit 104 determines that the entity to be measured is not in the environment in which the subject that is influenced by the entity to be measured exits (the result of the determination in step S3 is “NO”), the environment determination unit 104 returns the flow to step S2. On the other hand, when the environment determination unit 104 determines that the entity to be measured is in the environment in which the subject exists (the result of the determination in step S3 is “YES”), the environment determination unit 104 sends a subject presence signal indicating that the entity to be measured is in the environment in which the subject exists to the response determination unit 105.

The response determination unit 105 receives the subject presence signal from the environment determination unit 104. Upon reception of the subject presence signal, the response determination unit 105 determines, based on the person extraction result received from the sensor information analysis unit 102, whether the response from the subject (person) is received (step S4). Specifically, the response determination unit 105 uses an image analysis technique to identify the face direction of each person extracted by the sensor information analysis unit 102. When the identified face direction is toward the sensor 101, the response determination unit 105 determines that the response from the person is received. The response determination unit 105 determines that the greater the number of persons indicated by the person extraction result, turning their faces to the sensor 101, the more responses from the persons. Further, when the identified face direction is not toward the sensor 101, the response determination unit 105 determines that no response from the person is received.

When the response determination unit 105 determines that no response from the subject (person) is received (the result of the determination in step S4 is “NO”), the response determination unit 105 returns the flow to step S2. On the other hand, when the response determination unit 105 determines that the response from the subject (person) is received (the result of the determination in step S4 is “YES”), the response determination unit 105 sends the result of the determination as to the response from the subject to the influence calculation unit 106. The influence calculation unit 106 receives the response determination result from the response determination unit 105. The influence calculation unit 106 calculates the influence score based on the response determination result (step S5). Specifically, the influence calculation unit 106 outputs the number of subject responses indicated by the response determination result as the influence score by calculation. For example, when the number of responses indicated by the response determination result is 100, the influence calculation unit 106 outputs the influence score of “100” by calculation. When the number of responses indicated by the response determination result is 123, the influence calculation unit 106 outputs the influence score of “123” by calculation. The influence calculation unit 106 outputs the influence score to a monitor device such as a display and causes the monitor device to display the influence score (step S6).

Note that an output unit to which the influence calculation unit 106 outputs the influence score is not limited to a monitor device but may be a speaker. In that case, the influence calculation unit 106 outputs the influence score through the speaker as audible sound. In addition, the influence calculation unit 106 may record the influence score on another output unit (for example the storage unit 107). Further, a functional unit other than the influence calculation unit 106 may, for example, cause the influence score recorded on the storage unit 107 to be displayed on a monitor device such as a display. Further, a functional unit other than the influence calculation unit 106 may, for example, cause the influence score recorded on the storage unit 107 to be output through a speaker as audible sound.

As described above, the entity-to-be-measured identification unit 103 in the influence measurement device 10 identifies the entity to be measured that is likely to be the influencing subject such as a person. The environment determination unit 104 determines whether the entity to be measured identified by the entity-to-be-measured identification unit 103 is in the environment in which the subject that is influenced by the entity to be measured exists. The response determination unit 105 determines whether the response from the subject is received influenced by the entity to be measured identified by the entity-to-be-measured identification unit 103. Based on the response from the subject determined by the response determination unit 105, the influence calculation unit 106 calculates the influence score indicating the influence on the subjects. The influence calculation unit 106 outputs the influence score to a predetermined output unit. In this way, the influences of various entities to be measured, including moving entities such as persons and advertisement vehicles, on the subjects that exist in surroundings can be measured by the influence measurement device 10.

If functions of the influence measurement device 10 are implemented in a distributed manner in the network system 3 illustrated in FIG. 1, the entity to be measured needs to be identified because a functional unit provided in the entity to be measured communicates with functional units provided in devices other than the entity to be measured. For that purpose, the influence measurement device 10 needs to perform step 1 in FIG. 4. However, when all of the functions of the influence measurement device 10 are included in the entity to be measured, the influence measurement device 10 does not necessarily need to perform step S1 because information is sent and received within the influence measurement device 10.

Further, the entity to be measured is not limited to the advertisement vehicle 1 illustrated in FIG. 3. For example, the entity to be measured may be a person who is wearing an accessory, clothing, hair style or the like and appeals to the eye, a person who is wearing perfume or the like and appeals to the sense of smell, or a person who is carrying a loudspeaker that outputs audible information advertising a newly opened store or the like and appeals to the ear. Alternatively, the entity to be measured may be an animal or an object, other than a person. Further, the entity to be measured may be a person who acts three-dimensionally, such as an orator.

### Second Example Embodiment

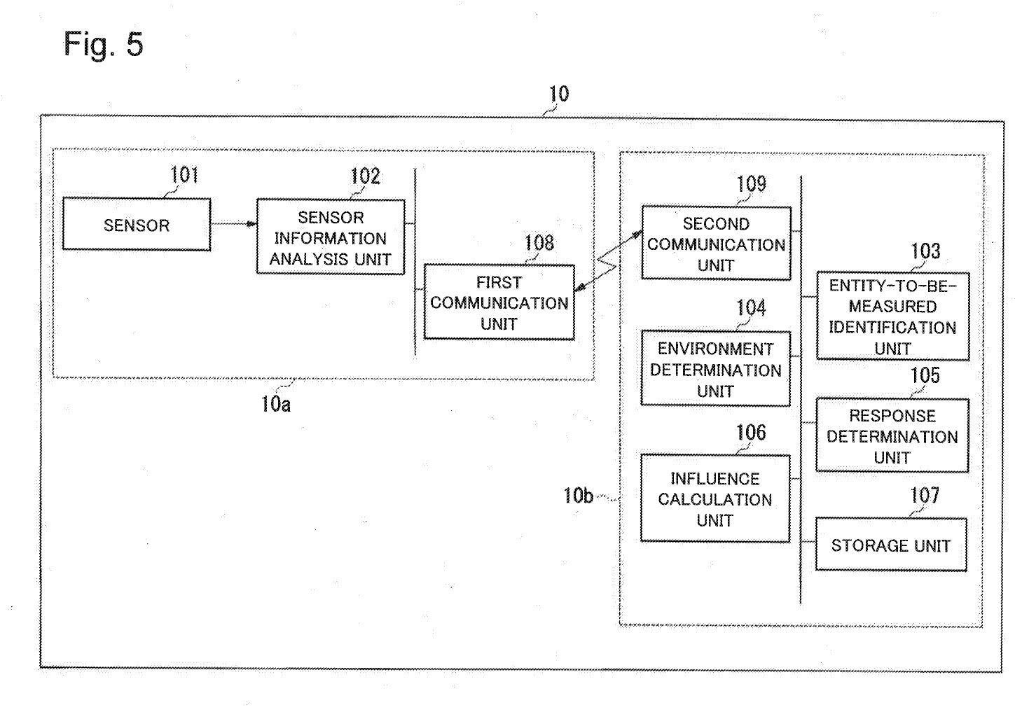

An influence measurement device 10 according to a second example embodiment will be described. FIG. 5 is a block diagram illustrating the influence measurement device 10 according to the second example embodiment. The influence measurement device 10 according to the second example embodiment includes components 101 to 107 as the influence measurement device 10 according to the first example embodiment, and, in addition, includes a first communication unit 108 and a second communication unit 109. Specifically, the influence measurement device 10 includes a first influence measurement device 10a and a second influence measurement device 10b. The first influence measurement device 10a includes the sensor 101, the sensor information analysis unit 102, and the first communication unit 108. The second influence measurement device 10b includes the entity-to-be-measured identification unit 103, the environment determination unit 104, the response determination unit 105, the influence calculation unit 106, the storage unit 107 and the second communication unit 109.

The sensor 101 detects a physical quantity for extracting a subject that is influenced by the entity to be measured. The sensor 101 is, for example, an image sensor that detects light and converts the light to image information.

The sensor information analysis unit 102 performs processing on the detection information indicating the physical quantity detected by the sensor 101. For example, when the sensor 101 is the image sensor, the sensor information analysis unit 102 acquires the image information from the sensor 101 and performs the image analysis such as face recognition on the image information to extract a person.

The entity-to-be-measured identification unit 103 identifies the entity to be measured that is likely to be the influencing the subjects such as persons. For example, the association between the ID of the influence measurement device 10 and the ID of the entity to be measured are stored in the storage unit 107 in advance and the entity-to-be-measured identification unit 103 reads out the association from the storage unit 107 to identify the entity to be measured that is likely to be the influencing subjects (the entity to be measured in which the sensor 101 is provided).

The environment determination unit 104 determines whether the entity to be measured is in an environment in which the subject that is influenced by the entity to be measured exists. For example, when the sensor information analysis unit 102 extracts a person from the detection information from the sensor 101, the environment determination unit 104 determines that the entity to be measured is in the environment in which the subject exists. When the sensor information analysis unit 102 does not extract a person from the detection information, the environment determination unit 104 determines that the entity to be measured is not in the environment in which the subject exists.

The response determination unit 105 determines whether the response from the subject (person) is received that is influenced by the entity to be measured. For example, the response determination unit 105 determines the direction of the face of each person extracted from the detection information by the sensor information analysis unit 102 using the image analysis technique. When the direction of the face of the person is toward the sensor 101, the response determination unit 105 determines that the response from the person is received. The response determination unit 105 determines that the greater the number of persons extracted by the sensor information analysis unit 102 and turning their faces to the sensor 101, the more responses are returned from the subjects. Further, when the face of the person is not turned to the sensor 101, the response determination unit 105 determines that no response from the person is received.

The influence calculation unit 106 calculates the influence score indicating the influence of the entity to be measured on a person based on responses from persons determined by the response determination unit 105. For example, when the number of responses from persons determined by the response determination unit 105 is 100, the influence calculation unit 106 outputs the influence score of “100” by calculation. When the number of responses from persons determined by the response determination unit 105 is 123, the influence calculation unit 106 outputs the influence score of “123” by calculation.

The storage unit 107 stores various kinds of information required for processing performed by the influence measurement device 10. For example, the storage unit 107 stores the association between the ID of the influence measurement device 10 and the ID of the entity to be measured.

The first communication unit 108 performs wireless communication with the second communication unit 109. For example, the first communication unit 108 sends a result of person extraction from the sensor information analysis unit 102 to the second communication unit 109. The second communication unit 109 receives the person extraction result from the first communication unit 108.

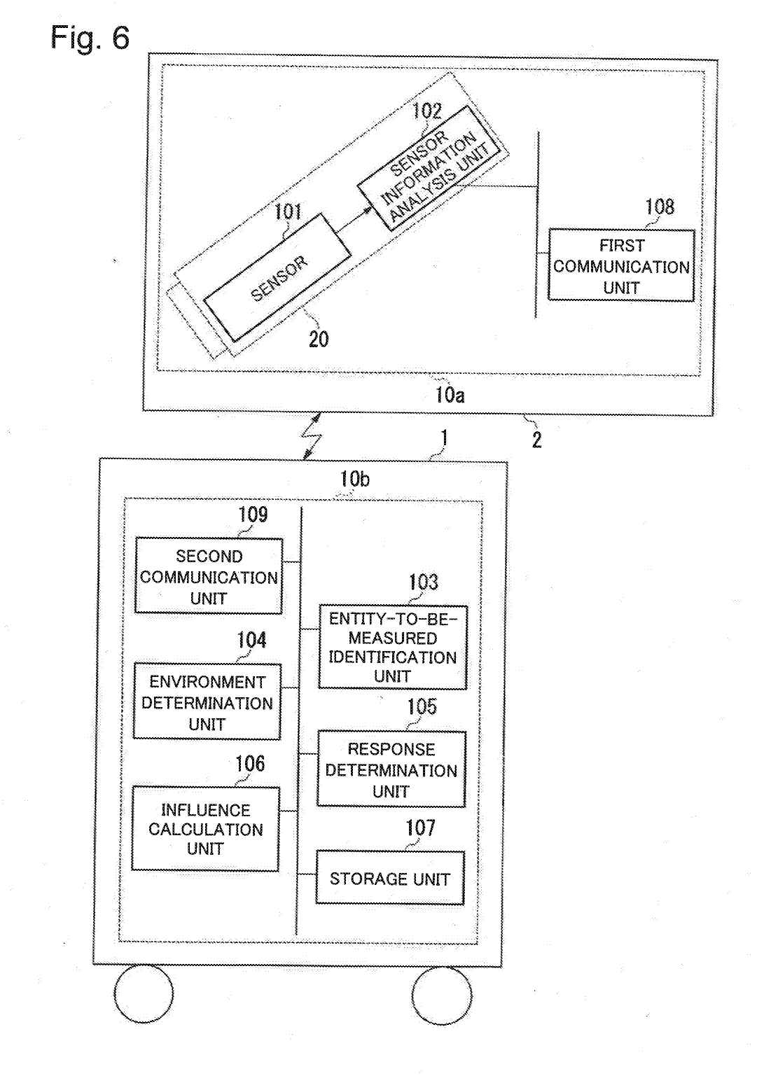

A procedure of processing performed by the influence measurement device 10 according to the second example embodiment will be described next. It is assumed that the second influence measurement device 10b is provided in the advertisement vehicle 1 which is the entity to be measured and the first influence measurement device 10a is provided in a flying object 2 that automatically follows the advertisement vehicle 1, as illustrated in FIG. 6. In this case, the advertisement vehicle 1 and the flying object 2 communicate with each other and the flying object 2 includes the function of automatically following the advertisement vehicle 1.

The procedure of processing performed by the influence measurement device 10 according to the second example embodiment is similar to the procedure of processing performed by the influence measurement device 10 according to the first example embodiment illustrated in FIG. 4. However, the second example embodiment differs from the first example embodiment in that the processing of automatically following the advertisement vehicle 1 by the flying object 2 and the processing of sending and receiving various kinds of information between the first communication unit 108 and the second communication unit 109 are provided in the second example embodiment. In addition, the camera 20 including the sensor 101 and the sensor information analysis unit 102 is provided in the flying object 2.

In the second example embodiment, when the advertisement vehicle 1 starts running along the predetermined route, the camera 20 starts to capture images. The flying object 2 follows the advertisement vehicle 1. For example, each of the advertisement vehicle 1 and the flying object 2 includes GPS capability. The flying object 2 acquires position information of each of the flying object 2 and the advertisement vehicle 1 using the GPS capability. The flying object 2 is controlled by a control unit included in the flying object 2 itself so as to follow and fly behind and above the advertisement vehicle 1 a predetermined distance relative to the position of the advertisement vehicle 1 for each time period, indicated by the position information of the advertisement vehicle 1.

The person extraction result of the sensor information analysis unit 102 in step S2 of FIG. 4 is sent to the second communication unit 109 through the first communication unit 108. Further, the environment determination unit 104 receives the person extraction result of the sensor information analysis unit 102 through the second communication unit 109.

As described above, in the influence measurement device 10 according to the second example embodiment, the entity-to-be-measured identification unit 103 identifies the entity to be measured that is likely to be the influencing subjects such as persons. The environment determination unit 104 determines whether the entity to be measured identified by the entity-to-be-measured identification unit 103 is in the environment in which the subject that is influenced by the entity to be measured exits. The response determination unit 105 determines whether the response from the subject that is influenced by the entity to be measured which is identified by the entity-to-be-measured identification unit 103 is received. Based on the responses from the persons determined by the response determination unit 105, the influence calculation unit 106 calculates the influence score indicating the influence of the entity to be measured on the persons. The influence calculation unit 106 outputs the influence score to the output unit (such as a display or a speaker). In this way, the influence measurement device 10 can measure the influences of various entities to be measured, including moving entities such as the persons and the advertisement vehicles, on the subjects that exist in surroundings.

### Third Example Embodiment

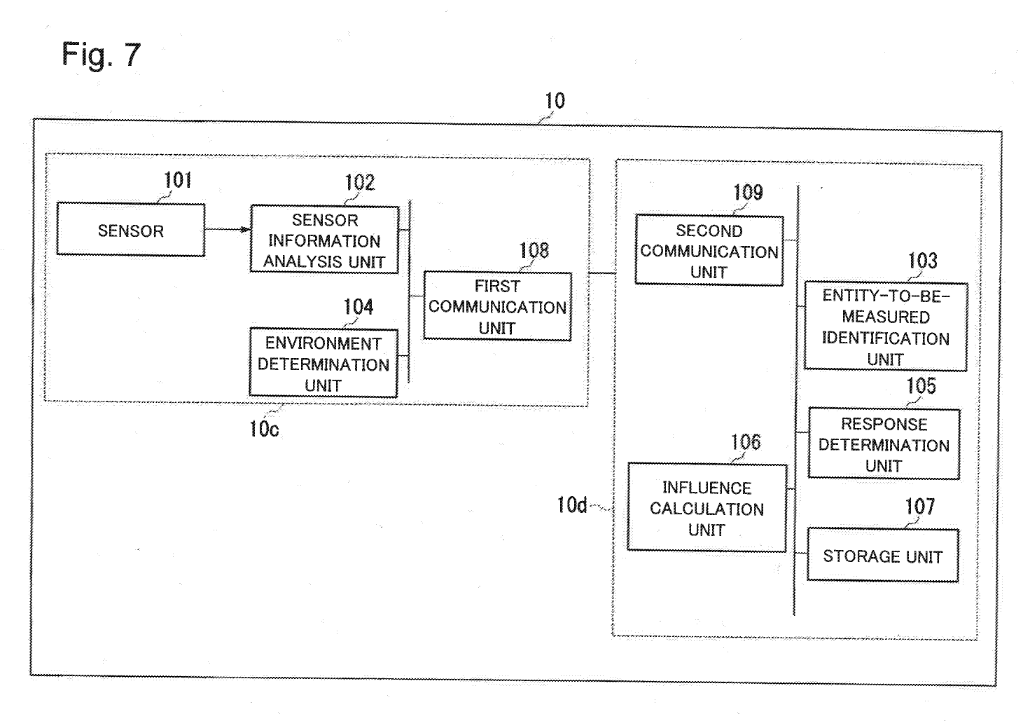

An influence measurement device 10 according to a third example embodiment of the present invention will be described. FIG. 7 is a block diagram of the influence measurement device 10 according to the third example embodiment. The influence measurement device 10 according to the third example embodiment includes components 101 to 109 similar to those of the influence measurement device 10 according to the second example embodiment. The influence measurement device 10 according to the third example embodiment includes a third influence measurement device 10c and a fourth influence measurement device 10d. The third influence measurement device 10c includes the sensor 101, the sensor information analysis unit 102, the environment determination unit 104, and the first communication unit 108. The fourth influence measurement device 10d includes the entity-to-be-measured identification unit 103, the response determination unit 105, the influence calculation unit 106, the storage unit 107 and the second communication unit 109.

The sensor 101 detects the physical quantity for extracting the subject that is influenced by the entity to be measured. The sensor 101 is, for example, the image sensor that detects light and converts the light to image information.

The sensor information analysis unit 102 performs processing on the information indicating the physical quantity detected by the sensor 101. For example, when the sensor 101 is the image sensor, the sensor information analysis unit 102 acquires the image information from the sensor 101 and performs the image analysis such as the face recognition on the image information to extract a person.

The environment determination unit 104 determines whether the entity to be measured is in the environment in which the subject that is influenced by the entity to be measured exists. For example, when the sensor information analysis unit 102 extracts a person from the detection information from the sensor 101, the environment determination unit 104 determines that the entity to be measured is in the environment in which the subject that is influenced by the entity to be measured exists. When the sensor information analysis unit 102 does not extract the person from the detection information, the environment determination unit 104 determines that the entity to be measured is not in the environment in which the subject exists.

The response determination unit 105 determines whether the response from the subject which is influenced by the entity to be measured is received. For example, the response determination unit 105 determines the direction of the face of each person extracted from the detection information by the sensor information analysis unit 102 using the image analysis technique. The response determination unit 105 draws imaginary straight lines extending in the directions of the faces of a plurality of persons and determines a point at which a greater number of straight lines than a predetermined number intersect each other. When an object exists at the position at which a greater number of straight lines than the predetermine number intersect each other, the response determination unit 105 determines that responses from subjects is received. In this case, the response determination unit 105 determines that the greater the number of intersecting lines, the greater the number of responses from subjects. Further, when no object exists at the point at which a greater number of straight lines than the predetermined number (predetermined threshold) intersect each other, the response determination unit 105 determines that no response from subjects is received. This is determination processing that considers the fact that when the subject is a person and the person pays attention to the entity to be measured, the person turns the face to the entity to be measured.

The influence calculation unit 106 calculates the influence score indicating the influence of the entity to be measured on the subjects based on the response of the subjects determined by the response determination unit 105. For example, when the number of straight lines intersecting each other at a particular point determined by the response determination unit 105 is 100, the influence calculation unit 106 outputs the influence score of “100” by calculation. When the number of straight lines intersecting each other at a particular point determined by the response determination unit 105 is 123, the influence calculation unit 106 outputs the influence score of “123” by calculation.

Based on the responses from the subjects, the entity-to-be-measured identification unit 103 identifies the entity to be measured that is the influencing subjects. For example, the entity-to-be-measured identification unit 103 identifies the object that corresponds to the influence score calculated by the influence calculation unit 106 that is greater than a predetermined threshold as the entity to be measured that is the influencing subjects.

The storage unit 107 stores various kinds of information required for processing performed by the influence measurement device 10. For example, the storage unit 107 stores the threshold used by the response determination unit 105 for determination processing and the threshold used by the entity-to-be-measured identification unit 103 for identification processing.

The first communication unit 108 communicates with the second communication unit 109. For example, the first communication unit 108 sends the result of person extraction from the detection information by the sensor information analysis unit 102 to the second communication unit 109. The second communication unit 109 receives the result of person extraction by the sensor information analysis unit 102 through the first communication unit 108. Further, when the environment determination unit 104 determines that the entity to be measured is in the environment in which the subject exists, the first communication unit 108 sends the subject-presence signal to the second communication unit 109. The second communication unit 109 receives the subject-presence signal through the first communication unit 108.

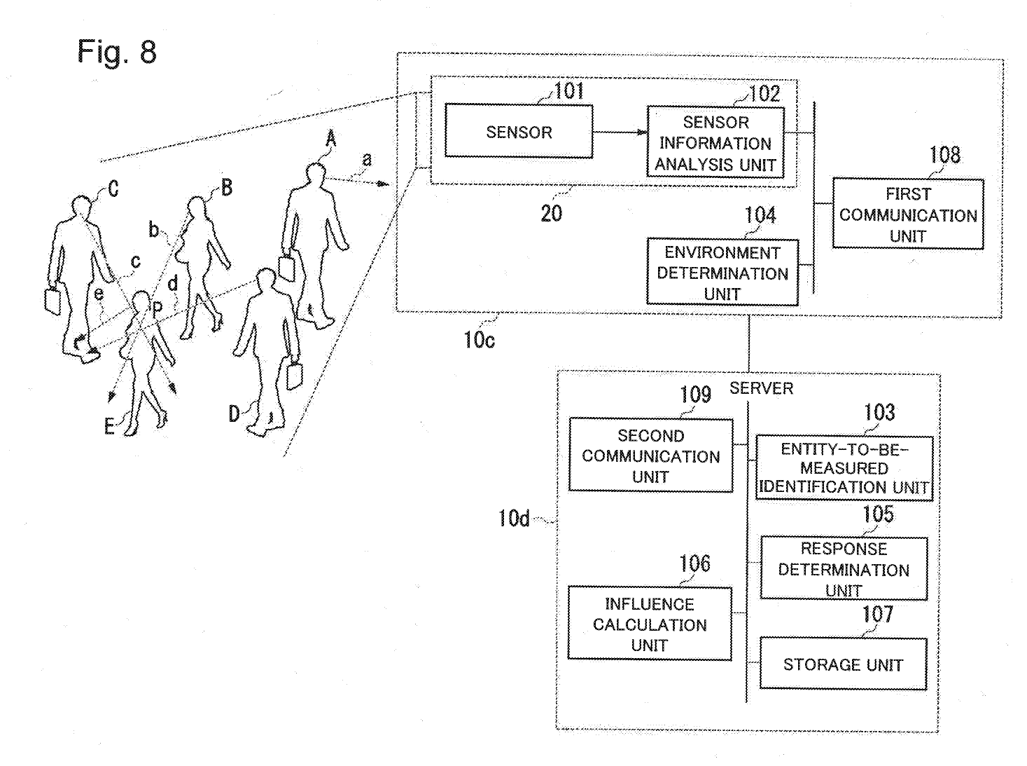

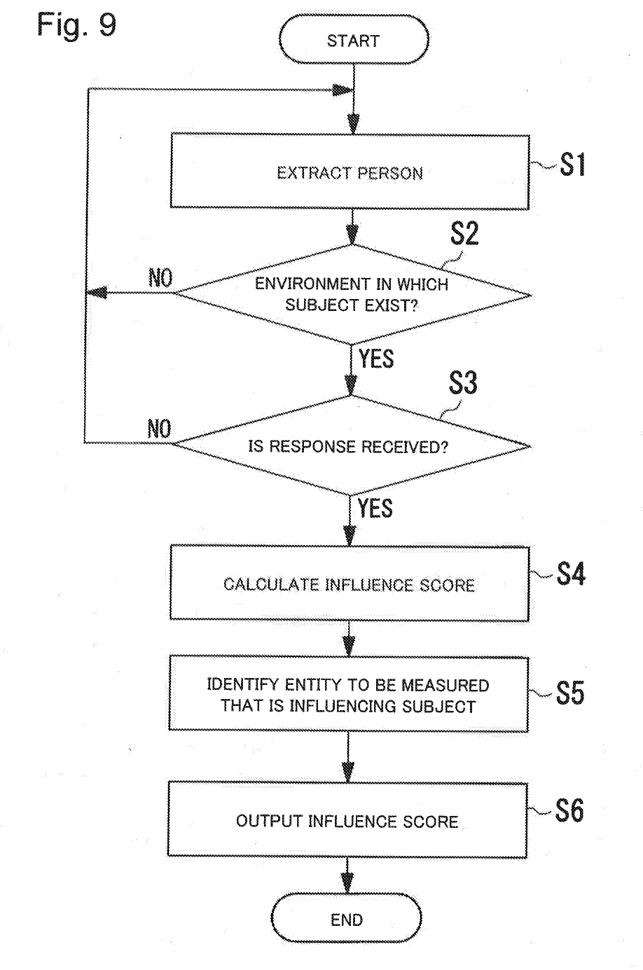

A procedure of processing performed by the influence measurement device 10 according to the third example embodiment will be described next. FIG. 8 illustrates the system in which the third influence measurement device 10c is provided in a shopping mall and the fourth influence measurement device 10d is incorporated in a server located remote from the third influence measurement device 10c. FIG. 9 illustrates a procedure of processing when the influence measurement device 10 according to the third example embodiment is applied to the system illustrated in FIG. 8. Note that the sensor 101 and the sensor information analysis unit 102 are embedded in the camera 20 provided in such a way that the camera 20 can capture images of subjects that exist in the shopping mall, and the sensor 101 is the image sensor embedded in the camera 20. The procedure of the processing performed by the influence measurement device 10 will be described here with the assumption that the entity to be measured that is likely to be the influencing subjects is a person.

First, the camera 20 starts capturing images. The sensor 101 converts light detected in a range in which images of a plurality of persons can be captured with the camera 20 provided in the shopping mall to image information.

The sensor information analysis unit 102 acquires the image information from the sensor 101 at regular intervals. The sensor information analysis unit 102 performs the image analysis such as the face recognition on the image information to extract persons (step S1). The sensor information analysis unit 102 sends the person extraction result to the second communication unit 109 through the first communication unit 108. Further, the sensor information analysis unit 102 sends the person extraction result to the environment determination unit 104.

The response determination unit 105 receives the person extraction result through the second communication unit 109. The environment determination unit 104 receives the person extraction result from the sensor information analysis unit 102. Based on the person extraction result, the environment determination unit 104 determines whether the entity to be measured is in the environment in which the subject that is likely to be influenced by the entity to be measured exists (step S2). Specifically, when the sensor information analysis unit 102 extracts a person from the detection information from the sensor 101, the environment determination unit 104 determines that the entity to be measured is in the environment in which the subject exists. On the other hand, when the sensor information analysis unit 102 does not extract a person from the detection information, the environment determination unit 104 determines that the entity to be measured is not in the environment in which the subject exists.

When the environment determination unit 104 determines that the entity to be measured is not in the environment in which the subject that is influenced by the entity to be measured exits (the result of the determination in step S2 is “NO”), the environment determination unit 104 returns the flow to step S1. On the other hand, when the environment determination unit 104 determines that the entity to be measured is in the environment in which the subject exists (the result of the determination in step S2 is “YES”), the environment determination unit 104 sends the subject presence signal indicating that the entity to be measured is in the environment in which the subject exists to the second communication unit 109 through the first communication unit 108. The response determination unit 105 receives the subject presence signal from the environmental determination unit 104 through the second communication unit 109. When the response determination unit 105 receives the subject presence signal, the response determination unit 105 determines, based on the person extraction result received from the sensor information analysis unit 102, whether the response from the subject is received (step S3). Specifically, the response determination unit 105 determines the direction of the face of each person extracted by the sensor information analysis unit 102 using the image analysis technique. The response determination unit 105 draws the imaginary straight line extending in the direction of the face of each person and identifies the position at which a greater number of straight lines than a predetermined number (a predetermined threshold) intersect each other. The response determination unit 105 then determines that the greater the number of interchanging straight lines, the greater the number of responses from persons. Further, when the number of interchanging lines is less than the predetermined number (the predetermined threshold) or when no object exists at the position at which straight lines intersect each other, the response determination unit 105 determines that no response from persons is received.

As an example, a case where persons A, B, C, D and E exist in a coverage of the camera 20 as illustrated in FIG. 8 will be described. The response determination unit 105 identifies the direction of the face of each of the persons A, B, C, D and E. Specifically, the response determination unit 105 identifies a straight line a extending in the direction of the face of the person A, a straight line b extending in the direction of the face of the person B, a straight line c extending in the direction of the face of the person C, a straight line d extending in the direction of the face of the person D, and a straight line e extending in the direction of the face of the person E. The response determination unit 105 identifies a position at which a greater number of straight lines a, b, c, d, e than a predetermined number (a predetermined threshold) intersect with each other. For example, when the predetermined number (the predetermined threshold) is three, the response determination unit 105 identifies a position P at which the straight lines b, c and d intersect each other. The response determination unit 105 determines whether a person exists at the position P based on the result of image analysis. As illustrated in FIG. 8, the response determination unit 105 determines that the person E exists at the position P and determines that the responses from a plurality of subjects is received (i.e. the persons B, C and D).

When the response determination unit 105 determines that no response from subjects which are influenced by the entity to be measured is received (the result of the determination in step S3 is “NO”), the response determination unit 105 returns the flow to step S1. On the other hand, when the response determination unit 105 determines that the responses from subjects is received (the result of the determination in step 3 is “YES”), the response determination unit 105 sends the result of the determination as to the responses from the subjects to the influence calculation unit 106. The influence calculation unit 106 receives the response determination result from the response determination unit 105. Based on the response determination result, the influence calculation unit 106 calculates the influence score (step S4). Specifically, when the number of straight lines that intersect a particular position determined by the response determination unit 105 is 100, the influence calculation unit 106 outputs the influence score of “100” by calculation. When the number of straight lines that intersect the particular position determined by the response determination unit 105 is 123, the influence calculation unit 106 outputs the influence score of “123” by calculation. In FIG. 8, the influence calculation unit 106 obtains from the response determination unit 105 the result of the response determination that indicates that three straight lines b, c and d intersect each other at the position P and that the person E exists at the position P. Based on the result of the response determination by the response determination unit 105, the influence calculation unit 106 outputs the influence score of “3” for the person E by calculation.

The entity-to-be-measured identification unit 103 identifies the entity to be measured that is the influencing subject based on the response from the subject. For example, the entity-to-be-measured identification unit 103 identifies the object that corresponds to the influence score calculated by the influence calculation unit 106 that is greater than or equal to the predetermined threshold as the entity to be measured that is the influencing subjects (step S5). The influence calculation unit 106 outputs the influence score to a monitor device such as a display to cause the monitor device to display the influence score (step S6).

As described above, in the influence measurement device 10 according to the third example embodiment, the environment determination unit 104 determines whether the entity to be measured is in the environment in which the subject that is influenced by the entity to be measured. The response determination unit 105 determines whether the response from the subject is received influenced by the entity to be measured. Based on responses from subjects determined by the response determination unit 105, the influence calculation unit 106 calculates the influence score indicating the influence of the entity to be measured on subjects. Based on the influence score calculated by the influence calculation unit 106, the entity-to-be-measured identification unit 103 identifies the entity to be measured that is the influencing subject. The influence calculation unit 106 outputs the influence score to the output unit (for example, a monitor device). In this way, the influence measurement device 10 according to the third example embodiment is capable of measuring influences of various entities to be measured, including moving entities such as persons and advertisement vehicles, on subjects in surroundings.

Note that, in the third example embodiment, the method by which the environment determination unit 104 determines whether the entity to be measured is in the environment in which the subject that is likely to be influenced by the entity to be measured exists is not limited to the determination method described above. For example, the environment determination unit 104 may determine whether the entity to be measured is in the environment in which the subject influenced by the entity to be measured exists based on at least one of the position of the entity to be measured and a time of day. Specifically, the entity to be measured is equipped with a device, such as a GPS device, that is capable of identifying positions. The environment determination unit 104 acquires position information from the device capable of identifying positions. For example, when the entity to be measured is moving in a place where there are many people (i.e. subjects) at any time of day or night, such as Shinjuku or Shibuya in Tokyo, Japan, the environment determination unit 104 determines that the entity to be measured is in the environment in which subjects that are influenced by the entity to be measured exist. On the other hand, when the entity to be measured is moving in the place where there is no person, such as woods or an extensive forest, the environment determination unit 104 determines that the entity to be measured is not in the environment in which the subject that is influenced by the entity to be measured exists. Note that when the entity to be measured cannot be identified in advance, a device capable of identifying positions may be provided at the sensor 101 of the influence measurement device 10.

Specific examples to which the environment determination unit 104 is applied will be described next. For example, the storage unit 107 stores relationship between each time of day and the number of subjects in a shopping mall in advance. The environment determination unit 104 reads out the relationship between each time of day and the number of subjects in the shopping mall from the storage unit 107. Specifically, the environment determination unit 104 reads out a time from a timer at the timing of determination. The environment determination unit 104 reads out the relationship of the time read out from the timer with the number of subjects from the storage unit 107. In the relationship read out from the storage unit 107, the environment determination unit 104 reads the number of subjects associated with the time read out from the timer. When the number of subjects read out from the storage unit 107 is not zero, the environment determination unit 104 determines that the entity to be measured is in an environment in which a subject that is influenced by the entity to be measured exists. On the other hand, when the number of subjects read from the storage unit 107 is zero, the environment determination unit 104 determines that the entity to be measured is not in the environment in which the subject that is influenced by the entity to be measured exists.

In another specific example, the entity to be measured is equipped with a device capable of identifying positions such as a GPS device. The storage unit 107 stores relationship between each time of day and the number of subjects at each position in advance. The environment determination unit 104 reads out the relationship between each time of day and the number of subjects at each position from the storage unit 107. Specifically, the environment determination unit 104 acquires position information from the device capable of identifying positions. The environment determination unit 104 reads out a time from a timer at the timing of determination. The environment determination unit 104 reads the relationship that matches the position information from the storage unit 107. The environment determination unit 104 refers to the relationship read out from the storage unit 107 based on the time read out from the timer and the position information to identify the number of subjects that correspond to the time and the position. When the number of subjects that is written in the relationship read out from the storage unit 107 is not zero, the environment determination unit 104 determines that the entity to be measured is in the environment in which the subject that is influenced by the entity to be measured exists. On the other hand, when the number of subjects is zero, the environment determination unit 104 determines that the entity to be measured is not in the environment in which the subject that is influenced by the entity to be measured exists. Note that when the entity to be measured cannot be identified in advance, the device capable of identifying positions may be provided at the sensor 101 of the influence measurement device 10.

In another specific example, the environment determination unit 104 may determine whether the entity to be measured is in the environment in which the subject that is influenced by the entity to be measured exists, based on a sound state in the surroundings of the entity to be measured. The entity to be measured is equipped with a device that captures sound in the surroundings, such as a microphone. The environment determination unit 104 acquires sound volume information from the device that captures sound in the surroundings of the entity to be measured and, when the sound volume is greater than or equal to a predetermined threshold, determines that the entity to be measured is in the environment in which the subject that is influenced by the entity to be measured exists. On the other hand, when the sound volume is smaller than the predetermined threshold, the environment determination unit 104 determines that the entity to be measured is not in the environment in which the subject that is influenced by the entity to be measured exists. Note that when the entity to be measured cannot be identified in advance, the device that captures sound in the surroundings of the entity to be measured may be provided at the sensor 101 of the influence measurement device 10.

In another specific example, the environment determination unit 104 may determine whether the entity to be measured is in the environment in which the subject that is influenced by the entity to be measured exists based on a communication state in the surroundings of the entity to be measured. In this example, each of the entity to be measured and subjects is equipped with a device capable of short-range communication. A procedure is determined in advance in which when the entity to be measured and the subject start communication, the short-range communication device of the subject sends a communication start notification signal indicating the start of communication to the environment determination unit 104. When the environment determination unit 104 receives the communication start notification signal, the environment determination unit 104 determines that the entity to be measured is in the environment in which the subject that is influenced by the entity to be measured exists. On the other hand, when the environment determination unit 104 does not receive the communication start notification signal, the environment determination unit 104 determines that the entity to be measured is not in the environment in which the subject that is influenced by the entity to be measured exists. Note that when the entity to be measured cannot be identified in advance, the environment determination unit 104 determines that the entity to be measured is in the environment in which the subject that is influenced by the entity to be measured exists when there is a short-range communication device that is concurrently communicating with a greater number of short-range communication devices than a predetermined threshold. On the other hand, when there is no short-range communication device that is concurrently communicating with a greater number of short-range communication devices than the predetermined threshold, the environment determination unit 104 determines that the entity to be measured is not in the environment in which the subject that is influenced by the entity to be measured exists.

In another specific example, the environment determination unit 104 may determine whether the entity to be measured is in the environment in which the subject that is influenced by the entity to be measured exists based on whether a device that is capable of distributing information concerning the entity to be measured exists in the vicinity of the entity to be measured. For example, a device capable of distributing information concerning the entity to be measured distributes a “button image” to be pressed when one is favorably impressed by the entity to be measured to subjects by short-range communication. The subjects are equipped with a device capable of short-range communication. A procedure is determined in advance in which when the short-range communication device of the subject receives the “button image”, the short-range communication device sends a reception notification signal notifying the reception of the “button image” to the environment determination unit 104. When the environment determination unit 104 receives the reception notification signal, the environment determination unit 104 determines that the entity to be measured is in the environment in which the subject that is influenced by the entity to be measured exists. On the other hand, when the environment determination unit 104 does not receive the reception notification signal, the environment determination unit 104 determines that the entity to be measured is not in the environment in which the subject that is influenced by the entity to be measured exists.

In the example described above, the method for the response determination unit 105 to determine whether the response from the subject which is influenced by the entity to be measured is received is not limited to the determination method described above. For example, the response determination unit 105 may determine whether the response from the subject is received based on a communication state in the surroundings of the entity to be measured. Alternatively, the response determination unit 105 may determine whether the response from the subject is received based on a sound state in the surroundings of the entity to be measured. Specifically, the entity to be measured is equipped with a device, such as a microphone, that captures sound in the surroundings. The response determination unit 105 acquires a sound volume from the device that captures sound in the surroundings of the entity to be measured and, when the sound volume is greater than or equal to a predetermined threshold, determines that the response from the subject which is influenced by the entity to be measured is received. On the other hand, when the sound volume is smaller than the predetermined threshold, the response determination unit 105 determines that no response from the subject is received. Note that when the entity to be measured cannot be identified in advance, a device that captures sound in the surroundings of the entity to be measured may be provided at the sensor 101 of the influence measurement device 10.

Further, the response determination unit 105 may determine whether the response from the subject is received based on the communication state in the surroundings of the entity to be measured. In this case, each of the entity to be measured and the subjects is equipped with the device that is capable of short-range communication. A procedure is determined in advance in which when the entity to be measured and the subject start communication, the short-range communication device of the subject sends the communication start notification signal notifying the start of communication to the response determination unit 105. When the response determination unit 105 receives the communication start notification signal, the response determination unit 105 determines that the response from the subject which is influenced by the entity to be measured is received. On the other hand, when the response determination unit 105 does not receive the communication start notification signal, the response determination unit 105 determines that no response from the subject is received. Note that in the case where the entity to be measured cannot be identified in advance, the response determination unit 105 determines that the response from the subject is received when there is a short-range communication device that is concurrently communicating with a greater number of short-range communication devices than a predetermined threshold. On the other hand, when there is no short-range communication device that is concurrently communicating with a greater number of short-range communication devices than the predetermined threshold, the response determination unit 105 determines that no response from the subject is received.

Note that as in the response determination unit 105 in the third example embodiment, the response determination units 105 according to the first example embodiment and the second example embodiment may determine whether the response from the subject is received based on the subject turning the face to the entity to be measured when the subject pays attention to the entity to be measured.

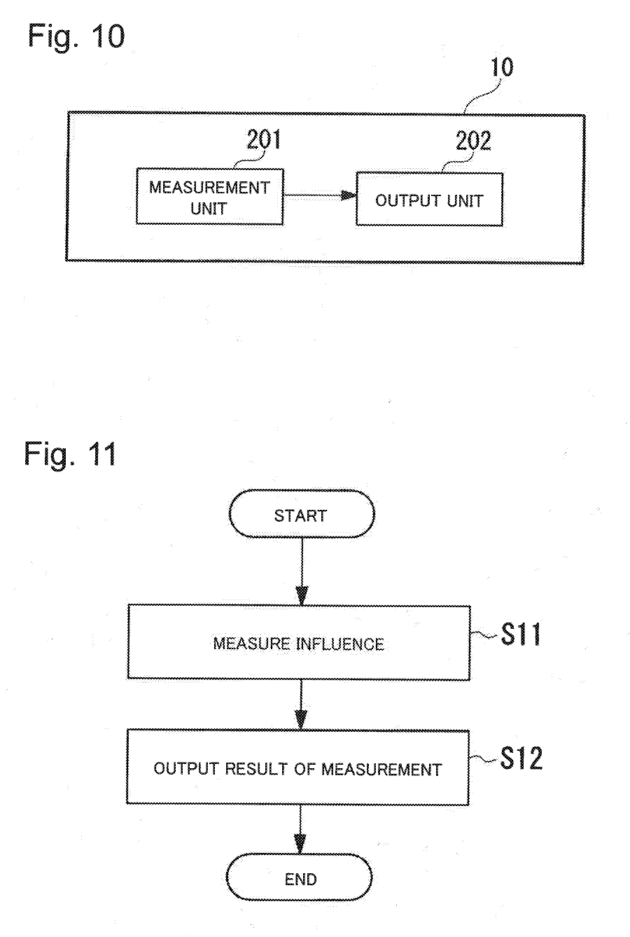

A minimum configuration of an influence measurement device 10 according to the present invention will be described next. FIG. 10 is a block diagram illustrating the minimum configuration of the influence measurement device 10 according to the present invention. The influence measurement device 10 includes at least a measurement unit 201 and an output unit 202. The measurement unit 201 measures influence of a moving first subject on a second subject. The output unit 202 outputs information concerning the influence of the first subject on the second subject. Here, the information concerning the influence is a result of measurement by the measurement unit 201 which measures the influence of the moving first subject on the second subject, for example.

FIG. 11 is a flowchart illustrating a procedure of processing performed by the influence measurement device 10 illustrated in FIG. 10. In the influence measurement device 10, the measurement unit 201 measures the influence of the moving first subject on the second subject (step S11). The measurement unit 201 sends a result of the measurement to the output unit 202. When the output unit 202 receives the result of the measurement from the measurement unit 201, the output unit 202 outputs the result of the measurement (step S12).

Note that the storage unit 107 in the examples described above may be provided anywhere within a range in which desired information can be sent and received. Further, a plurality of storage units 107 may be provided and data may be stored in the storage units 107 in a distributed manner within a range in which desired information can be sent and received.

Note that the order of performance of steps in the procedures of the processing in the examples described above may be changed as appropriate as long as the functions of the influence measurement device 10 according to the present invention can be achieved.

The influence measurement device 10 according to the present invention includes a computer system therein. Any of the procedures of processing described above is stored in a computer-readable storage medium in the form of a program. Any of the processing procedures described above is performed by a computer reading the program from the storage medium and executing the program. Here, the computer-readable storage medium is a magnetic disk, a magneto-optical disk, a CD-ROM, a DVD-ROM, a semiconductor memory or the like. The computer program may be delivered to a computer through a communication line and the computer may execute the program.

The program described above may be a program that implements some of the functions of the influence measurement device 10. Further, the program may be a program that can implement the functions of the influence measurement device 10 in combination with a program already recorded on a computer system, i.e. a so-called differential program (a differential file).

Lastly, the present invention is not limited to the examples and the specific examples described above and encompasses design changes and modifications within the scope of the present invention defined by the attached claims.

### INDUSTRIAL APPLICABILITY

The present invention related to the influence measurement device and the influence measurement method is applied to measure the influence of advertising media (such as persons or advertisement vehicles) on subjects (such as persons), and then may be applied to measure the influence of an information source other than advertising media on the subjects.

### REFERENCE SIGNS LIST

1 Advertisement vehicle
2 Flying object
10 Influence measurement device
10a First influence measurement device
10b Second influence measurement device
10c Third influence measurement device
10d Fourth influence measurement device
20 Camera
30 Edge server
40 Cloud server
101 Sensor
102 Sensor information analysis unit
103 Entity-to-be-measured identification unit (identification unit)
104 Environment determination unit (first determination unit)
105 Response determination unit (second determination unit)
106 Influence calculation unit
107 Storage unit
108 First communication unit
109 Second communication unit
201 Measurement unit
202 Output unit

What is claimed is:

1. An influence measurement device comprising:
a processor that is configured to:
measure an influence of a moving first subject on a second subject; and
output the influence measured by the measurement unit.

2. The influence measurement device according to claim 1, wherein the processor that is further configured to:
determine whether the second subject which is likely to be influenced by the moving first subject exists; and
determine whether a response from the second subject is received.

3. The influence measurement device according to claim 2,
wherein the processor that is further configured to identify the moving first subject based on the response from the second subject.

4. The influence measurement device according to claim 2, wherein the processor determines, at each predetermined time interval, whether the second subject which is likely to be influenced by the moving first subject exists.

5. The influence measurement device according to claim 2, wherein the processor determines whether the second subject which is likely to be influenced by the moving first subject exists based on at least one of a position of the moving first subject and a time of day.

6. The influence measurement device according to claim 2, wherein the processor determines whether the second subject which is likely to be influenced by the moving first subject exists based on a sound state in surroundings of the moving first subject.

7. The influence measurement device according to claim 2, wherein the processor determines whether the second subject which is likely to be influenced by the moving first subject exists based on a communication state in surroundings of the moving first subject.

8. The influence measurement device according to claim 2, wherein the processor determines whether the second subject which is likely to be influenced by the moving first subject exists based on a determination of whether a device capable of distributing information about the moving first subject exists in surroundings of the moving first subject.

9. The influence measurement device according to claim 2, wherein the processor determines whether the response from the second subject is received based on a predetermined behavior detected from image data obtained by capturing an image of the second subject.

10. The influence measurement device according to claim 9, wherein the processor determines whether the response from the second subject is received based on a behavior in which the second subject turns to the moving first subject, the behavior being detected from the image data.

11. The influence measurement device according to claim 9, wherein the image data represents an image of the second subject observed from the moving first subject.

12. The influence measurement device according to claim 2, wherein the processor determines whether the response from the second subject is received based on communication data from a device capable of distributing information about the moving first subject.

13. The influence measurement device according to claim 2, wherein the processor determines whether the response from the second subject is received based on information about sound in surroundings of the moving first subject.

14. An influence measurement method comprising:
by processor,
measuring an influence of a moving first subject on a second subject; and,
outputting the measured influence.

15. A non-transitory program storage medium storing a computer program causing a computer to execute:
measuring an influence of a moving first subject on a second subject; and,
outputting the measured influence.
